(19) United States
(12) Patent Application Publication
(10) Pub. No.: US 2016/0232705 A1
(43) Pub. Date: Aug. 11, 2016

(54) Method for 3D Scene Reconstruction with Cross-Constrained Line Matching

(71) Applicant: Mitsubishi Electric Research Laboratories, Inc., Cambridge, MA (US)

(72) Inventor: Srikumar Ramalingam, Cambridge, MA (US)

(21) Appl. No.: 14/617,963

(22) Filed: Feb. 10, 2015

(51) Int. Cl. G06T 15/20; G02B 27/01; G06K 9/46; G06K 9/62; G06T 7/00

(52) U.S. Cl. CPC G06T 15/20; G06K 9/6201; G06T 7/0085; G06K 9/4604; G02B 27/01; G06T 2200/04; G06T 2207/30242

(57) ABSTRACT

A method reconstructs a three-dimensional (3D) scene using a pair of 2D images acquired from two different viewpoints by first detecting real lines in the pair of images, and then matching points in the pair of images to detect matched points. Virtual lines in the pair of images are generated using pairs of the matched points, and then detecting additional matched points on the virtual lines using a cross-ratio constraint. Line matching is performed using all matching points to detect matched lines, and then a line-based 3D reconstruction of the scene, from the matched lines.

### FIELD OF THE INVENTION

This invention relates generally to image processing and computer vision, and more particularly to three-dimensional (3D) scene reconstruction using lines.

### BACKGROUND OF THE INVENTION

Many three-dimensional (3D) scene reconstruction methods use point and plane correspondences. The success can be attributed to the numerous tools for point and plane based scene reconstruction.

Lines are dominant in most urban scenes, such as street views. However, lines are less frequently used in 3D reconstruction than points and planes. Although numerous fundamental results have been derived on line reconstruction, those techniques are seldom applied in practice. The primary reason is the lack of good line descriptors and noise in line detection procedures. Several geometrical and constraint satisfaction methods solve this problem for simple synthetic line drawings.

In the context of multi-view geometry, several methods are known for matching and reconstructing lines using trifocal tensors. While single-view line reconstruction is still a challenging problem, the case of multi-view is more-or-less solved in the geometrical sense. However, the challenges in real images are completely different. The conventional and purely geometrical approaches rely on the fact that the lines are detected up to sub-pixel accuracy and matched without outliers.

In contrast to the point descriptors, the line descriptors mostly rely on nearby points and are not accurate when matching lines across images. These issues in detecting and matching lines lead to severe degradation of the reconstruction. While 3D reconstruction from points can be done from random street view images with unknown camera parameters, line reconstruction still requires careful calibration to provide useful results.

Some methods use trifocal tensor constraints and degeneracies involved in the process of line reconstruction from three views. Another method matches lines from two or more images using cross-correlation scores from neighboring lines. Most line matching methods use nearby points or color to match the lines, see e.g., Verhagen et al., “Scale-invariant line descriptors for wide baseline matching,” WACV 2014 for a survey.

One method for solving the 3D reconstruction of lines uses pencil of points (POPs) on lines, Bartoli et al., “A framework for pencil-of-points structure-from-motion,” ECCV, 2004. Many line matching and reconstruction methods match a large number of lines and reconstruct the lines using intersection of planes. Explicit pixel-wise correspondences for individual points on lines can also be used.

Some line reconstruction methods use Manhattan or Atlanta worlds, see Ramalingam et al., “Lifting 3D Manhattan lines from a single image,” ICCV, 2013, and Schindler et al., “Atlanta world: An expectation maximization framework for simultaneous low-level edge grouping and camera calibration in complex man-made environments,” CVPR, pages 203-209, 2004.

Connectivity constraints can be very useful for obtaining accurate line reconstruction from multiple images. Many methods solve an optimization problem for various locations of 3D line segments to best match projections.

There are also tracking based edge and line reconstruction methods for video sequences. In particular LSD-SLAM, Engel et al., “LSD-SLAM: Largescale direct monocular SLAM,” ECCV, 2014. If we can track edges accurately, this also mean that we can track lines. However, tracking lines in wide-baseline images is difficult using these methods.

Cross-correlation methods can also be used in line matching. Most prior art methods match lines using intensity and color profiles strictly in a local neighborhood or in patches close to a line.

There are a number of dense reconstruction methods such as Patch-based Multi-view Stereo (PMVS), SURE, Rothermel et al., “SURE: Photogrammetric surface reconstruction from imagery,” LC3D Workshop, 2012.

### SUMMARY OF THE INVENTION

The embodiments of the invention provide a cross-ratio constraint for wide-baseline line-matching and three-dimensional (3D) scene reconstruction. Most prior art 3D reconstruction methods use points and planes from images because lines have been considered inadequate for line matching and reconstruction due to the lack of good line descriptors.

The method matches a pencil of points (POPs) on lines using a cross-ratio constraint by considering several pairs of point correspondences. The cross-ratio constraint yields an initial set of point matches on lines, which are subsequently used to determine line correspondences.

The method uses a point-based technique to obtain line reconstruction. The line-matching can be done in calibrated and uncalibrated settings.

By considering pairs of feature point matches, virtual lines can be formed across the images. By looking at places where the virtual lines intersect real lines in images, and using cross-ratio constraint, pixels on the virtual lines can be matched to the real lines. By accumulating these correspondences, lines can be matched.

Note that many prior line detection methods only match lines from one image to another, and there are no pixel-wise correspondence between lines. In the present invention, pixel-wise correspondences between line segments are determined to produce dense point-wise correspondences.

### BRIEF DESCRIPTION OF THE DRAWINGS

FIGS. 1A and 1B are schematics of conventional cross-ratio constraint in projective geometry for one and two viewpoints, respectively;

FIG. 2 is a schematic of two perspective synthetic images taken from different viewpoints;

FIG. 3 is a schematic of a line-sweep operation in a calibrated setup according to embodiments of the invention;

FIG. 4 is a schematic of a line-sweep for stereo images based on epipolar lines; and

FIG. 5 is a flow diagram of a method for 3D scene reconstruction according to the embodiments of the invention.

### DETAILED DESCRIPTION OF THE PREFERRED EMBODIMENTS

The embodiments of the invention provide a cross-ratio constraint for wide-baseline line-matching and three-dimensional (3D) scene reconstruction from a pair of images acquired of scene.

The method uses pairs of point matches to produce line correspondences. Three embodiments are described. The invention is based on a cross-ratio constraint, as described below. Herein, the term “points” is used to refer to specific pixels in the images.

Cross-Ratio Constraint

In projective geometry, a cross-ratio is a fundamental invariant. The cross-ratio, also called a double ratio and an anharmonic ratio, is a number associated with a list of four collinear points, particularly points on a projective line.

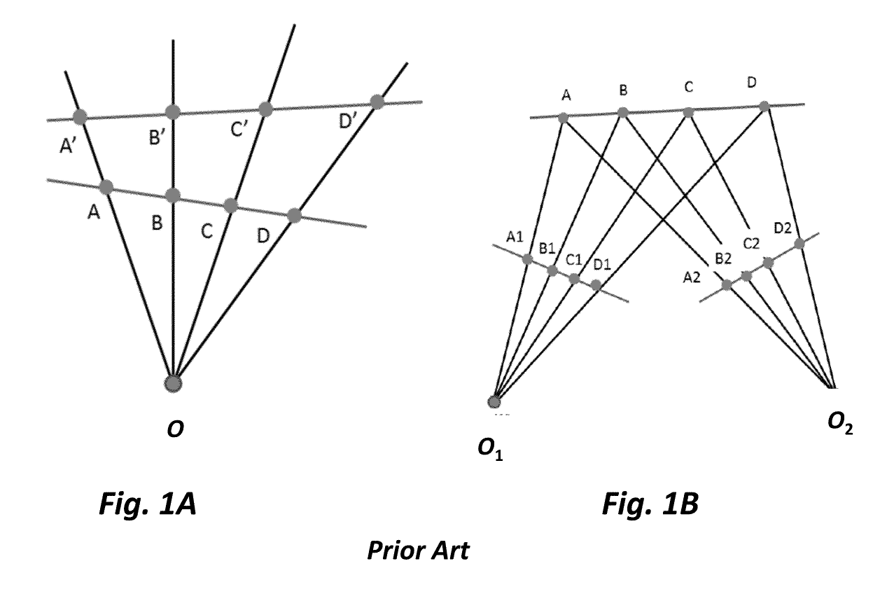

FIG. 1A shows a pencil of lines starting at a viewpoint O and intersecting a line l₁ at four points (A, B, C, D). The pencil of lines is the set of lines that pass through a given point in a projective plane. The same pencil of lines also intersect another line l₂ at four points (A′, B′, C′, D′). The cross-ratio for the collinear points on line l₁ is defined as

$$\{ A , B ; C , D \} = \frac{\vert AC \vert \times \vert AD \vert}{\vert BC \vert \times \vert BD \vert} . \qquad ( 1 )$$

For line l₂ intersecting the pencil of lines, a cross-ratio {A′, B′; C′, D′} can be determined, where {A, B; C, D}={A′, B′; C′, D′}.

FIG. 1B shows cross-ratio constraints from four collinear points observed from two different viewpoints O₁ and O₂. Here, {A₁, B₁; C₁, D₁}={A₂, B₂; C₂, D₂}.

Basic Setup

The lines directly detected from pixels in the image are called real lines. The lines used for identifying additional correspondences are called virtual lines.

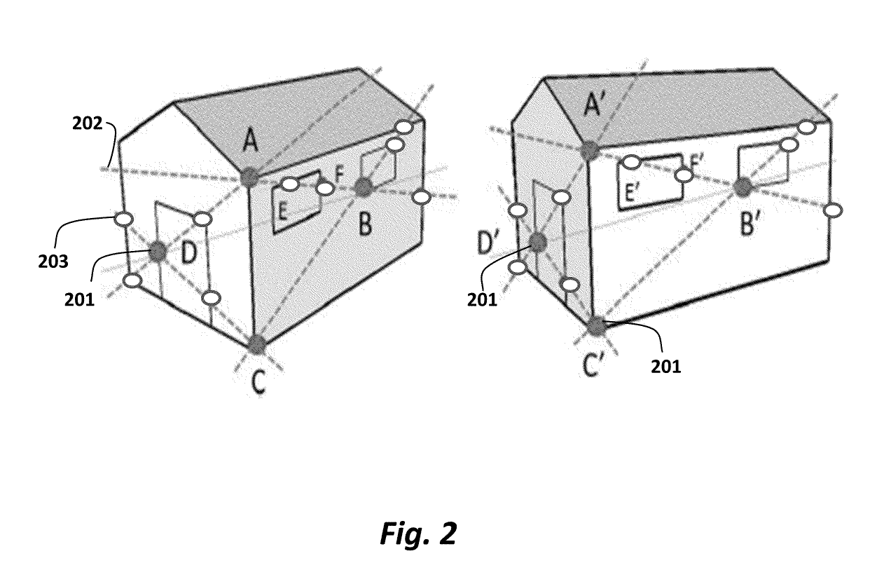

FIG. 2, for examplary purposes, shows two perspective synthetic images taken from different viewpoints. There are four initial matching points shown as black dots 201 in both the perspective synthetic images. By selecting pairs of point matches, one can form virtual lines (dotted) 202, where one can search for additional point matches. By selecting several such search lines, nine new point matches 203 (white dots). The point matching can be performed by a scale-invariant feature transform (SIFT).

For example, in FIG. 2, the line 201 joining A and B is referred to as a virtual line and the line at the boundary of the window of the house having the point E as a real line. Given a pair of point matches, the virtual line joining the points are used to generate additional matching points in the images. This provides a cross-ratio constraint. The cross-ratio constraint is only applied to pixels on real lines.

Each virtual line generates additional matches based on where the virtual lines intersect with the real lines in the scene. It is important to note that these virtual lines need not lie on a plane in the scene, although virtual lines lying on a plane generate a large number of correspondences in comparison to lines not lying on a plane in the scene.

FIG. 2 shows four initial point matches (solid dots A, B, C and D) in two perspective images taken from the two different viewpoints. These four initial point matches can be determined using the SIFT descriptors. Several pairs of such point matches are used to generate additional point matches on the virtual lines. It can be observed that by using as few as four point matches, one can obtain, e.g., nine additional point matches. In real images with many lines and points, a combinatorial number of virtual lines and additional points can be obtained to determine most of the real lines the entire image. Three embodiments are described: uncalibrated, calibrated, and stereo.

Uncalibrated

In FIG. 2, consider a pair of point matches {(A, A′), (B, B′)}. Let the virtual line passing through A and B be denoted by AB. Where the virtual line AB intersect a real line is referred to as a line-crossing. For example, points E and F are referred to as the line-crossings of AB.

One additional match (E, E′) is obtained using one line-crossing each in AB and A′B′. Using these three point matches {(A, A′), (B, B′), (E, E′)}, one can determine additional matches. In order to do this, first determine the cross-ratio {A, B; E, F} for every new point F lying on AB. Using this point F and the determined cross-ratio {A, B; E, F}, one can determine the corresponding point F′ on A′B′. If the pixel F′ is a line-crossing on A′B′, then one match is determined, and one can search for additional matches with the hypothesized match (E, E′).

The goal is to determine at least one additional matching point that generates the maximal number of newer match points on the corresponding virtual lines AB and A′B′. For identifying the additional match E, E′, there can be n² possibilities. However, using ordering constraints and other proximity priors, the complexity can be reduced significantly in practice.

Calibrated

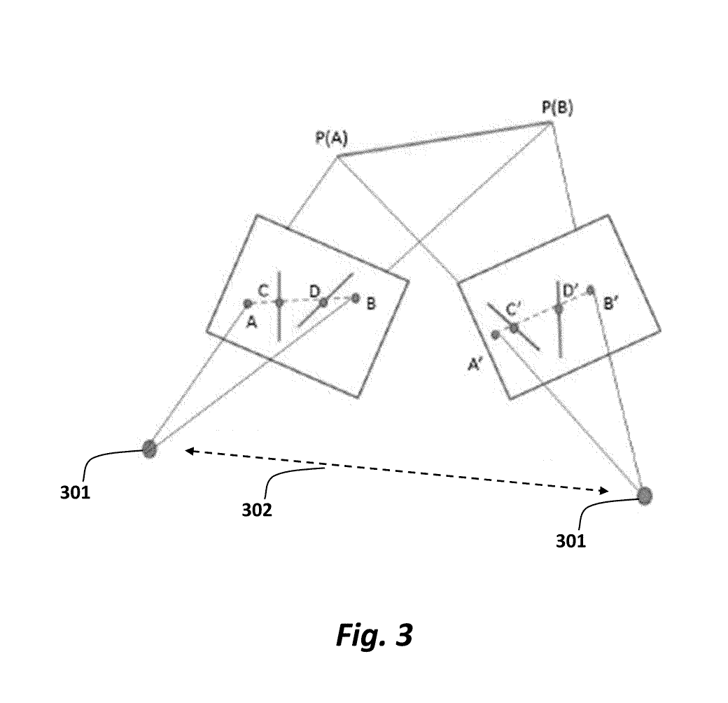

In the presence of camera calibration and relative motion between the cameras, the search space for determining matches reduces significantly. This is shown in FIG. 3 for the line-sweep operation in a calibrated setup. The camera calibration parameters and relative motion 302 of the cameras 301 are known. This allows one to determine point matches (C, C′) and (D, D′) very efficiently. It is understood that in an uncalibrated setup, the relative motion may be unknown, so that the motion needs to be computed.

Consider a pair of point matches {(A, A′), (B, B′)}. Because one can determine the depth information using the calibration information, one can also determine the 3D points P(A) and P(B). This allows one to determine the 3D point corresponding to any intermediate line-crossing points on AB. The 3D point P(C) for the line-crossing C is determined. It can be observed that this 3D point P(C) lies on the 3D line P(A)P(B). We project the point P(C) on A′B′. If the projection point is C′, and the point is a line-crossing on A′B′, then a match has been determined. The complexity is O(n) on the number of line-crossings on the virtual line. This operation can be done much faster than in the uncalibrated case.

Stereo

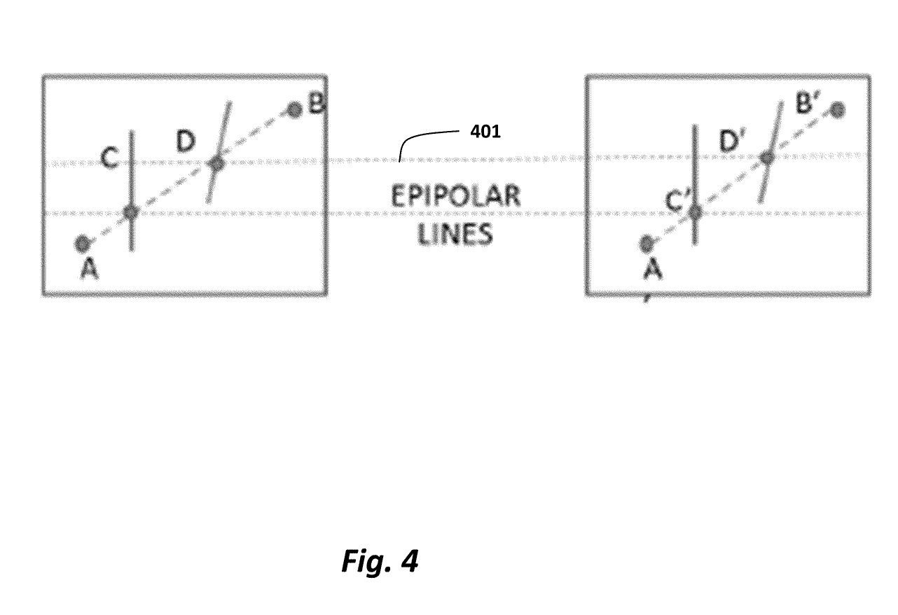

FIG. 4 shows the basic idea behind the line-sweep for stereo images based on epipolar lines 401. For rectified stereo images, determining additional point correspondences is a simple look-up that does not require any additional operation. In this embodiment, the line-sweep is a simple operation. Consider two corresponding virtual lines AB and A′B′. For every line-crossing on AB, if there is a corresponding line-crossing on A′B′ with the same y coordinate, then there is a match.

Semi-Dense Stereo Reconstruction

Instead of using lines, the lines can correspond toCanny edges. From a single pair of stereo images, using line-sweeping, it is possible to obtain a semi-dense stereo reconstruction.

Reconstruction Method

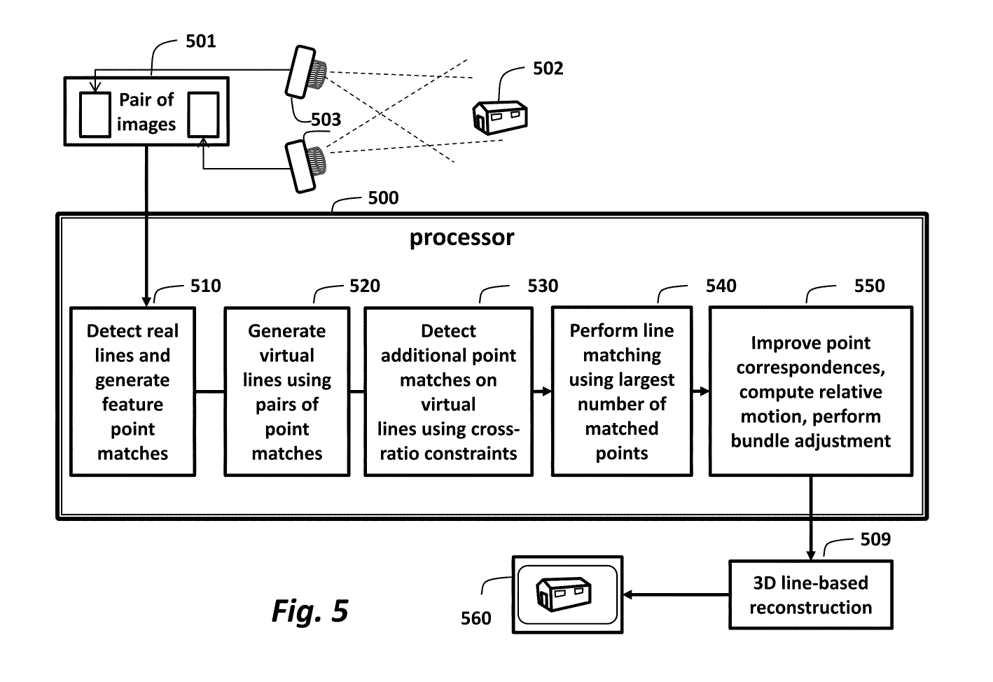

FIG. 5 shows the steps in our the method. Input for the method is a pair of two-dimensional (2D) images 501 acquired of a scene 502 by a pair of cameras at two different viewpoints. The images can be synthetic, that is generated using by a computer. Detect real lines and generate feature point matches 510 in the pair of images 501. The matched points are used to generate virtual lines 520 in the pair of images for a line sweeping operation that detect 530 additional matching points on the virtual lines using cross-ratio constraints.

Then, lines in the pair of images are matched 540 using all the points that are matched on the lines. For a line in the first image, a corresponding line in the second image is determined, which shares the largest number of point matches in a “winner-takes-all” strategy.

Next, improve the point correspondences using the matched lines, compute relative motion, and perform point-based bundle adjustment 550. The bundle adjustment concurrently refines the 3D coordinates describing the geometry of the scene geometry as well as the parameters of the relative motion of the cameras. Finally, produce a 3D line-based reconstruction 509 of the scene. The 3D reconstruction can be rendered to an output device 560, e.g., a display unit.

The method can be performed in a processor connected to memory and input/output interfaces by buses as known in the art.

Conclusion

The embodiments of the invention uses cross-ratio constraints for mapping point matches to line correspondences. The method produces accurate line-matching performance, as well as large-scale line reconstruction. The lines can be reconstructed from point clouds denoting pencils of points (POPs), where all the points are associated with their corresponding lines during the line matching process. It is straightforward to convert the point cloud to line segments by line-fitting. In this case a point-based 3D model is converted to a large 3D line-based model.

In other words, the invention transforms images of real world scenes or virtual scenes into a line-based 3D reconstruction. The method can be used to efficiently reconstruct lines from multiple images and can be used for indoors and outdoor scenes. Practical applications can include:

3D reconstruction of relatively large road scenes for car navigation, obstacle detection and tracking. In this case, the 3D reconstruction can be displayed to a driver, using, e..g., a head-up display;

3D reconstruction of robotic platform for collision avoidance applications;

3D reconstruction of indoor scenes for improving the efficiency of household appliances such televisions, heating ventalation, vacuum cleaners, and air conditioning (HVAC) systems;

3D reconstruction for digital signage applications; and

3D reconstruction of walls and floor for tracking people in surveillance applications.

Although the invention has been described by way of examples of preferred embodiments, it is to be understood that various other adaptations and modifications may be made within the spirit and scope of the invention. Therefore, it is the object of the appended claims to cover all such variations and modifications as they come within the true spirit and scope of the invention.

I claim:

1. A method for reconstructing a three-dimensional (3D) scene, comprising steps:
acquiring a pair of two-dimensional (2D) images of the scene from two different viewpoints;
detecting real lines in the pair of images;
finding point correspondences in the pair of images to obtain matched points;
generating virtual lines in the pair of images using pairs of the matched points;
detecting additional matched points on the virtual lines using a cross-ratio constraint;
finding line correspondences using all matching points to obtain matched lines; and
determing a line-based 3D reconstruction of the scene, from the matched lines, wherein the steps are performed in a processor connected to a memory storing the pair of images.

2. The method of claim 1, wherein a relative motion between the pair of images is unknown.

3. The method of claim 1, wherein the motion between the pair of images is known.

4. The method of claim 1, wherein the pair of images is a pair of rectified stereo images.

5. The method of claim 1, wherein the line matching is performed by detecting pairs of lines that share a maximal number of matched points.

6. The method of claim 1, wherein the line-based 3D reconstruction is refined using a point-based bundle adjustment.

7. The method of claim 1, wherein multiple images are used to obtain a large line-based 3D model by processing the images one pair at a time.

8. The method of claim 1, wherein a large point-based 3D model is converted to a large line-based 3D model.

9. The method of claim 1, wherein the pair of images is acquired by a camera.

10. The method of claim 1, wherein the pair of images is computer generated.

11. The method of claim 1, wherein the real lines are obtained using Canny edges.

12. The method of claim 1, further comprising:
rendering the line-based 3D reconstruction.

13. The method of claim 12, wherein the rendering is to a head-up display.
